(19) United States
(12) Patent Application Publication
(10) Pub. No.: US 2024/0100987 A1
(43) Pub. Date: Mar. 28, 2024

(54) METHOD AND SYSTEM FOR CONTROLLING AUTOMATIC BATTERY SWAPPING OF RAIL VEHICLE, ELECTRONIC DEVICE, AND STORAGE MEDIUM

(71) Applicant: BYD COMPANY LIMITED, SHENZHEN (CN)

(72) Inventors: Hao LU, Shenzhen (CN); Zhicheng TAN, Shenzhen (CN); Hongtao SHE, Shenzhen (CN); Mingyang GUO, Shenzhen (CN); Keqi ZHANG, Shenzhen (CN)

(21) Appl. No.: 18/535,895

(22) Filed: Dec. 11, 2023

Related U.S. Application Data
(63) Continuation of application No. PCT/CN2022/106660, filed on Jul. 20, 2022.

(30) Foreign Application Priority Data
Aug. 31, 2021 (CN) 202111015634.0

(51) Int. Cl. B60L 53/80; B61L 27/10; B61L 27/70

(52) U.S. Cl. CPC B60L 53/80; B61L 27/10; B61L 27/70; B60L 2200/26

(57) ABSTRACT

A method for controlling automatic battery swapping of a rail vehicle, includes: receiving vehicle information sent by the rail vehicle; determining whether the rail vehicle has a battery swapping need based on the vehicle information of the rail vehicle; in response to determining that the rail vehicle has the battery swapping need, determining a target battery swapping station according to the battery swapping need; and sending a battery swapping notification signal and a vehicle control signal to the rail vehicle, and sending a battery swapping request signal to the target battery swapping station, where the battery swapping notification signal includes position information of the target battery swapping station, the vehicle control signal controls the rail vehicle to travel to the target battery swapping station, and the battery swapping request signal includes identification information of the rail vehicle and requests the target battery swapping station to swap a battery pack for the rail vehicle.

### CROSS-REFERENCE TO RELATED APPLICATIONS

This application is a Continuation Application of International Patent Application No. PCT/CN2022/106660, filed on Jul. 20, 2022, which is based on and claims priority to and benefits of Chinese Patent Application No. 202111015634.0, filed on Aug. 31, 2021. The entire content of all of the above-referenced applications is incorporated herein by reference.

### FIELD

The present disclosure relates to the technical field of rail vehicles, and in particular, to a method and a system for controlling automatic battery swapping of a rail vehicle, an electronic device, and a storage medium.

### BACKGROUND

Currently, carbon emission reduction becomes a major issue, and electric vehicles are favored by the governments and consumers in response to continuous breakthroughs in the new energy technologies. However, problems of electric vehicles such as a short driving range and an excessively long charging time are drawing more attention, which are bottlenecks that restrict large-scale development of electric vehicles, especially for commercial rail vehicles.

### SUMMARY

In view of the above, the present disclosure provides a method and a system for controlling automatic battery swapping of a rail vehicle, an electronic device, and a storage medium. In the method for controlling automatic battery swapping of a rail vehicle provided in the present disclosure, rail vehicles and battery swapping stations are managed through a battery swapping management platform. Based on vehicle information fed back by the rail vehicles, it is determined whether the rail vehicles have a battery swapping need, and a battery swapping station satisfying a battery swapping need is determined or planned for a rail vehicle having the corresponding battery swapping need, thereby achieving automatic matching between the rail vehicles and the battery swapping stations. This improves an automation level of battery swapping of rail vehicles.

A first aspect of the present disclosure provides a method for controlling automatic battery swapping of a rail vehicle, which is applicable to a battery swapping management platform. The method includes: receiving, by the battery swapping management platform, vehicle information sent by the rail vehicle, where the vehicle information includes current position information and current power information of the rail vehicle; determining, by the battery swapping management platform, whether the rail vehicle has a battery swapping need based on the vehicle information of the rail vehicle; in response to determining that the rail vehicle has the battery swapping need, determining, by the battery swapping management platform, a target battery swapping station according to the battery swapping need; and sending, by the battery swapping management platform, a battery swapping notification signal and a vehicle control signal to the rail vehicle, and sending a battery swapping request signal to the target battery swapping station, where the battery swapping notification signal includes position information of the target battery swapping station, the vehicle control signal is configured to control the rail vehicle to travel to the target battery swapping station, and the battery swapping request signal includes identification information of the rail vehicle and is configured to request the target battery swapping station to swap a battery pack for the rail vehicle.

According to the method for controlling automatic battery swapping of a rail vehicle provided in the present disclosure, the vehicle information of the rail vehicle is received, so that the battery swapping need of the rail vehicle may be accurately determined, thereby achieving scheduling and planning for rail vehicles and battery swapping stations. This not only achieves efficient and reliable operation of the system, but also achieves automatic matching between the rail vehicle and the target battery swapping station through synchronous control of the rail vehicle and the target battery swapping station, thereby improving the automation level of battery swapping.

A second aspect of the present disclosure provides an method for controlling automatic battery swapping of a rail vehicle, which is applicable to a rail vehicle. The method includes: sending, by the rail vehicle, vehicle information of the rail vehicle to a battery swapping management platform; where the vehicle information includes current position information and current power information of the rail vehicle, where the battery swapping management platform is configured to determine whether the rail vehicle has a battery swapping need based on the vehicle information of the rail vehicle, and to send a battery swapping notification signal and a vehicle control signal to the rail vehicle when determining that the rail vehicle has the battery swapping need, and where the battery swapping notification signal includes position information of a target battery swapping station; receiving, by the rail vehicle, the battery swapping notification signal and the vehicle control signal sent by the battery swapping management platform, and travelling to the target battery swapping station according to the battery swapping notification signal and the vehicle control signal; and exchanging, by the rail vehicle, battery swapping information with the target battery swapping station for the target battery swapping station to swap a battery pack of the rail vehicle based on the battery swapping information.

According to the method for controlling automatic battery swapping of a rail vehicle provided in the present disclosure, based on the relevant battery swapping instruction signal sent by the battery swapping management platform, the rail vehicle may be automatically controlled to travel and park at a target battery swapping location, so that the target battery swapping station performs a battery swapping operation. In addition, in the method, the battery swapping information is exchanged between the rail vehicle and the target battery swapping station, so that the target battery swapping station performs battery swapping based on the exchanged information without intervention of an operator, thereby reducing labor costs and improving battery swapping efficiency.

A third aspect of the present disclosure provides an method for controlling automatic battery swapping of a rail vehicle, which is applicable to a battery swapping station. The method includes: receiving, by the battery swapping station, a battery swapping request signal sent by a battery swapping management platform, where the battery swapping request signal includes identification information of the rail vehicle; and exchanging, by the battery swapping station, battery swapping information with the rail vehicle based on the identification information of the rail vehicle, and swapping a battery pack of the rail vehicle based on the battery swapping information.

According to the method for controlling automatic battery swapping of a rail vehicle provided in the present disclosure, a communication connection to the target rail vehicle is automatically established based on the battery swapping request signal sent by the battery swapping management platform, which achieves precise matching between each carriage and a corresponding battery swapping apparatus, so that the battery swapping apparatus may be controlled to swap a battery pack of the corresponding carriage, thereby achieving a more intelligent battery swapping process.

A fourth aspect of the present disclosure provides a system for controlling automatic battery swapping of a rail vehicle. The system includes a rail vehicle, a battery swapping management platform, and multiple battery swapping stations. The rail vehicle is configured to send vehicle information of the rail vehicle to the battery swapping management platform, where the vehicle information includes current position information and current power information of the rail vehicle. The battery swapping management platform is configured to receive the vehicle information sent by the rail vehicle, and determine whether the rail vehicle has a battery swapping need based on the vehicle information of the rail vehicle. The battery swapping management platform is further configured to: in response to determining that the rail vehicle has the battery swapping need, determine a target battery swapping station according to the battery swapping need from the multiple battery swapping stations, and send a battery swapping notification signal and a vehicle control signal to the rail vehicle and send a battery swapping request signal to the target battery swapping station, where the battery swapping notification signal includes position information of the target battery swapping station, and the vehicle control signal is configured to control the rail vehicle to travel to the target battery swapping station. The battery swapping request signal includes identification information of the rail vehicle, and is configured to request the target battery swapping station to swap the battery pack for the rail vehicle. The rail vehicle is further configured to receive the battery swapping notification signal and the vehicle control signal sent by the battery swapping management platform, and travel to the target battery swapping station according to the battery swapping notification signal and the vehicle control signal. The target battery swapping station is configured to receive the battery swapping request signal sent by the battery swapping management platform, to exchange battery swapping information with the rail vehicle based on the identification information of the rail vehicle included in the battery swapping request signal, and to swap the battery pack of the rail vehicle based on the battery swapping information.

According to the system for controlling automatic battery swapping of a rail vehicle provided in the present disclosure, scheduling and planning of rail vehicles and battery swapping stations are performed through the battery swapping management platform, the battery swapping management platform obtains vehicle information of each rail vehicle to monitor a battery swapping need of the rail vehicle, and coordinated scheduling of the rail vehicles and the battery swapping stations are performed to satisfy the battery swapping needs of the rail vehicles in a timely manner. In this way, it may be ensured that the rail vehicles can reliably and efficiently complete operation plans. In addition, during battery swapping, the rail vehicle and the battery swapping station automatically perform matching and exchange information based on the signal sent by the battery swapping management platform, which improves the automation level of battery swapping.

A fifth aspect of the present disclosure provides an electronic device, including a processor and a memory. The memory stores instructions executable by the processor. The instructions, when executed by the processor, cause the processor to perform the methods for controlling automatic battery swapping of a rail vehicle in the above first aspect, or in the above second aspect, or in the above third aspect.

A sixth aspect of the present disclosure provides a non-transitory computer-readable storage medium for storing instructions. The instructions, when executed, implementing the method for controlling automatic battery swapping of a rail vehicle in the above first aspect, or in the above second aspect, or in the above third aspect.

Additional aspects and advantages of the present disclosure are provided in the following description, some of which will become apparent from the following description or may be learned from practices of the present disclosure.

### BRIEF DESCRIPTION OF THE DRAWINGS

FIG. 1 is a schematic structural diagram of a system for controlling automatic battery swapping of a rail vehicle according to an embodiment of the present disclosure.

FIG. 2 is a schematic flowchart of interaction among a rail vehicle, a battery swapping management platform, and a target battery swapping station in the system for controlling automatic battery swapping of a rail vehicle according to an embodiment of the present disclosure.

FIG. 3 is a step flowchart of a method for controlling automatic battery swapping of a rail vehicle according to an embodiment of the present disclosure.

FIG. 4 is a detailed flowchart of step 602 in FIG. 3.

FIG. 5 is a step flowchart of another method for controlling automatic battery swapping of a rail vehicle according to an embodiment of the present disclosure.

FIG. 6 is a step flowchart of calculating a range of a rail vehicle according to an embodiment of the present disclosure.

FIG. 7 is a step flowchart of still another method for controlling automatic battery swapping of a rail vehicle according to an embodiment of the present disclosure.

FIG. 8 is a schematic structural diagram of an electronic device according to an embodiment of the present disclosure.

The present disclosure is further described below with reference to the above drawings in the following detailed description.

### DETAILED DESCRIPTION

The technical solutions in embodiments of the present disclosure are described clearly and completely below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without making creative efforts fall within the protection scope of the present disclosure.

In addition, terms “first” and “second” are used merely for description, and shall not be construed as indicating or implying relative importance or implying a quantity of indicated technical features. Therefore, a feature limited by “first” or “second” may explicitly or implicitly include one or more of the features. In the description of the present invention, unless otherwise explicitly specified, “multiple” means two or more than two.

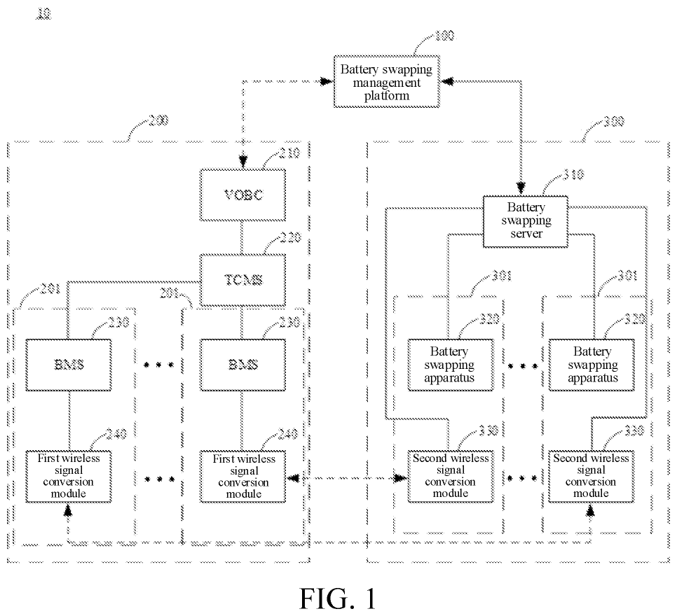

FIG. 1 is a schematic structural diagram of a system for controlling automatic battery swapping of a rail vehicle according to an embodiment of the present disclosure. As shown in FIG. 1, a system 10 for controlling automatic battery swapping of a rail vehicle includes a battery swapping management platform 100, multiple rail vehicles 200, and multiple battery swapping stations 300. For ease of illustration, only one rail vehicle 200 and one battery swapping station 300 are shown in FIG. 1.

In this embodiment of the present disclosure, the battery swapping management platform 100 is configured to compile a train diagram for each of the rail vehicles 200 in the system and communicate with each rail vehicle through train-ground wireless communication. For example, the battery swapping management platform receives running data of each rail vehicle 200 in real time or periodically, and sends a notification signal or a control signal to each rail vehicle, so as to ensure that the rail vehicle can travel as planned. In an embodiment, the wireless communication manner may include an LTE-U communication manner or other communication manners. The train diagram is a technical document that illustrates operations of the rail vehicles in a track section and moments at which the rail vehicles arrive at, depart from, or pass through a station. The operation diagram specifies procedures that the rail vehicles should follow in that section, moments at which the rail vehicles arrive at and depart from (or pass through) each station, durations of the operation of the rail vehicles in the section, and durations of dwelling of the rail vehicles in the section, and is a basis for systematically arranging operation of the rail vehicles.

The battery swapping management platform 100 is further configured to communicate with each of the battery swapping stations 300, plan/determine a target battery swapping station for the rail vehicle 200 when the rail vehicle has a battery swapping need, and request the target battery swapping station to replenish power for the rail vehicle 200, so as to ensure that the rail vehicle 200 has sufficient power to complete the operation plan.

In this embodiment of the present disclosure, the rail vehicle 200 includes a vehicle on-board controller (VOBC) 210, a train control and management system (TCMS) 220, and multiple carriages 201. The TCMS 220 is electrically connected with the VOBC 210. The VOBC 210 is configured to communicate with the battery swapping management platform 100 through train-ground wireless communication. For example, the VOBC sends vehicle information from the TCMS 220 of the vehicle to the battery swapping management platform 100 in real time or periodically, and receives a notification signal or a control signal sent by the battery swapping management platform 100, so that the battery swapping management platform 100 may monitor the vehicle information of the rail vehicle 200 in real-time, including a capacity of a battery pack and the like, and perform overall planning properly to ensure that the rail vehicle 200 has sufficient power to complete the operation plan.

In this embodiment of the present disclosure, each of the carriages 201 includes a battery pack (not shown in the figure) and a battery management system (BMS) 230. Each carriage 201 is independently powered by a battery pack thereof. For the same carriage, the BMS 230 is connected with the TCMS 220 and the battery pack. The BMS 230 is configured to monitor battery information of the corresponding battery pack in real time and send the battery information to the TCMS 220. The TCMS 220 may at least obtain vehicle information of the rail vehicle 200 based on the battery information of the corresponding battery pack provided by each BMS 230.

During the battery swapping, each battery management system 230 communicates with a target battery swapping station 300 to exchange battery swapping information.

In this embodiment, the battery swapping information sent by the BMS 230 is a CAN signal. Each carriage 201 further includes a first wireless signal conversion module 240 (e.g., a first wireless signal converter). For the same carriage, the first wireless signal conversion module 240 is electrically connected with the BMS 230. The first wireless signal conversion module 240 is configured to convert the CAN signal sent by the BMS 230 into a wireless signal and forward the wireless signal to the battery swapping station 300, and to convert a received wireless signal into a CAN signal and forward the CAN signal to the BMS 230. That is to say, the BMS 230 of each carriage 201 communicates with the target battery swapping station 300 through wireless communication by the corresponding first wireless signal conversion module 240, to exchange battery swapping information of the battery pack of the corresponding carriage 201.

In this embodiment of the present disclosure, the battery swapping station 300 includes a battery swapping server 310 and multiple battery swapping sites 301. The battery swapping server 310 is electrically connected with the battery swapping management platform (for example, connected through the Internet). The battery swapping server 310 is configured to communicate with the battery swapping management platform 100. For example, the battery swapping server receives a battery swapping request signal sent by the battery swapping management platform 100 or send a usage status signal of the battery swapping sites 301 to the battery swapping management platform 100. Each of the battery swapping sites 301 is equipped with a battery swapping apparatus 320. Each battery swapping apparatus 320 is electrically connected with the battery swapping server 310. Each battery swapping apparatus 320 is configured to swap the battery pack for the carriage 201 that stops at the corresponding battery swapping site.

In this embodiment, each battery swapping site 301 is further equipped with a second wireless signal conversion module 330 (e.g., a second wireless signal converter). Each second wireless signal conversion module 330 is electrically connected with the battery swapping server 310. The battery swapping server 310 is further configured to perform wireless communication with the rail vehicle 200 through the second wireless signal conversion module 330. A Wi-Fi signal has advantages such as stability and a wide coverage. Therefore, for example, both the first wireless signal conversion module 240 and the second wireless signal conversion module 330 may use a CAN Wi-Fi signal conversion module.

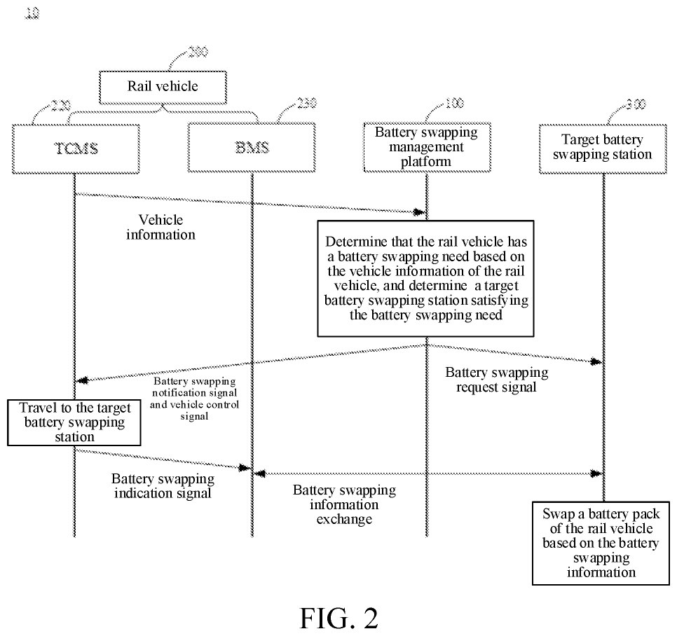

In an embodiment, referring to FIG. 1 and FIG. 2, during running, the rail vehicle 200 sends vehicle information of the vehicle to the battery swapping management platform 100 through the TCMS 220. The vehicle information includes at least current position information and current power information of the rail vehicle 200. The vehicle information is used by the battery swapping management platform 100 to determine whether the rail vehicle 200 has a battery swapping need. It should be noted that, in this embodiment of the present disclosure, the communication between the TCMS 220 and the battery swapping management platform 100 is implemented through the VOBC 210. For example, the TCMS 220 sends the vehicle information of the vehicle to the VOBC 210. Then the VOBC 210 sends the vehicle information to the battery swapping management platform 100 through wireless communication. In order to simplify the interaction flowchart, the VOBC 210 is omitted in FIG. 2.

The battery swapping management platform 100 determines whether the rail vehicle 200 has a battery swapping need based on the vehicle information of the rail vehicle 200 when receiving the vehicle information sent by the rail vehicle 200.

The battery swapping management platform 100 plans, for the rail vehicle 200, a target battery swapping station 300 satisfying the battery swapping need from the multiple battery swapping stations 300 when determining that the rail vehicle 200 has the battery swapping need, and sends a battery swapping notification signal and a vehicle control signal to the rail vehicle 200 and sends a battery swapping request signal to the target battery swapping station 300. The battery swapping notification signal includes at least position information of the target battery swapping station 300, and the vehicle control signal is configured to control the rail vehicle 200 to travel to the target battery swapping station 300 to swap a battery pack. The battery swapping request signal includes at least identification information of the rail vehicle 200, and is configured to request the target battery swapping station 300 to swap the battery pack for the rail vehicle 200.

The TCMS 220 of the rail vehicle 200 controls the rail vehicle 200 to travel to the target battery swapping station 300 when receiving the battery swapping notification signal and the vehicle control signal sent by the battery swapping management platform 100. After the rail vehicle 200 stops at a target battery swapping location of the target battery swapping station 300, the TCMS 220 of the rail vehicle 200 sends a battery swapping indication signal to each BMS 230. Each BMS 230 exchanges battery swapping information with the target battery swapping station 300 in response to the battery swapping indication signal, so that the target battery swapping station 300 swaps the battery pack of the rail vehicle 200 based on the exchanged battery swapping information.

The target battery swapping station 300 exchanges battery swapping information with the rail vehicle 200 based on the identification information of the rail vehicle 200 included in the battery swapping request signal when receiving the battery swapping request signal sent by the battery swapping management platform 100, and swaps the battery pack of the rail vehicle 200 based on the exchanged battery swapping information.

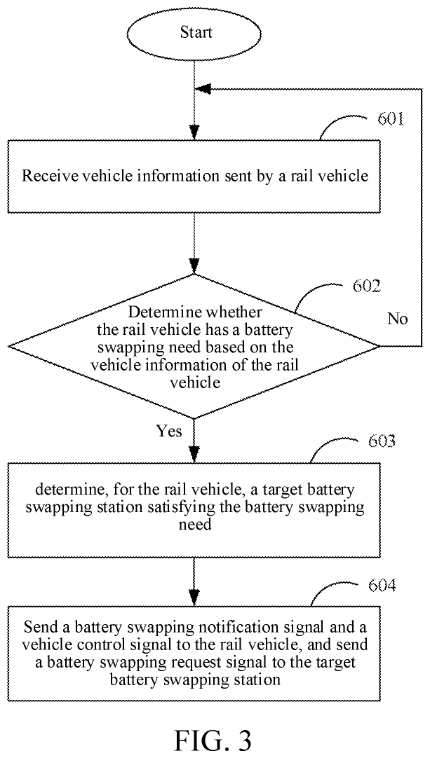

In an embodiment, for technical details of the steps performed by the rail vehicle 200, the battery swapping management platform 100, and the target battery swapping station 300 in the interaction process in this embodiment, refer to the following description of method embodiments shown in FIG. 3 to FIG. 7.

According to the system 10 for controlling automatic battery swapping of a rail vehicle provided in the present disclosure, unified scheduling and planning of the rail vehicles 200 and the battery swapping stations 300 are performed through the battery swapping management platform 100, the battery swapping management platform 100 obtains vehicle information of each rail vehicle 200 to monitor whether the rail vehicle 200 has a battery swapping need, and coordinated scheduling of the rail vehicles 200 and the battery swapping stations 300 are performed to satisfy the battery swapping needs of the rail vehicles 200 in a timely manner. In this way, it may be ensured that the rail vehicles can reliably and efficiently complete operation plans. In addition, during battery swapping, the rail vehicle 200 and the battery swapping station 300 automatically perform matching and exchange information based on the signal sent by the battery swapping management platform 100, which improves the automation level of battery swapping.

Referring to FIG. 3, an embodiment of the present disclosure provides a method for controlling automatic battery swapping of a rail vehicle, which is applicable to a battery swapping management platform 100. In an embodiment, the method includes the following steps.

Step 601: Vehicle information sent by a rail vehicle 200 is received. The vehicle information includes current position information and current power information of the rail vehicle 200. In an embodiment of this application, the rail vehicle 200 may send the vehicle information thereof to the battery swapping management platform 100 in real time or periodically.

Step 602: It is determined whether the rail vehicle 200 has a battery swapping need based on the vehicle information of the rail vehicle 200. If it is determined that the rail vehicle 200 has the battery swapping need, step 603 is performed. Otherwise, step 601 is re-performed to receive the vehicle information sent by the rail vehicle 200.

Step 603: A target battery swapping station 300 satisfying the battery swapping need is planned for the rail vehicle 200.

Step 604: A battery swapping notification signal and a vehicle control signal are sent to the rail vehicle 200, and a battery swapping request signal is sent to the target battery swapping station 300.

The battery swapping notification signal includes position information of the target battery swapping station 300. In an embodiment, the position information may include position information of a target battery swapping area in the target battery swapping station 300. The vehicle control signal is configured to control the rail vehicle 200 to travel to the target battery swapping station 300 to swap a battery pack. The battery swapping request signal includes identification information of the rail vehicle 200, and is configured to request the target battery swapping station 300 to swap the battery pack for the rail vehicle 200. It may be understood that the target battery swapping station 300 may identify the rail vehicle 200 based on the identification information (for example, an identification code of the rail vehicle), thereby achieving automatic matching between the target battery swapping station 300 and the rail vehicle 200.

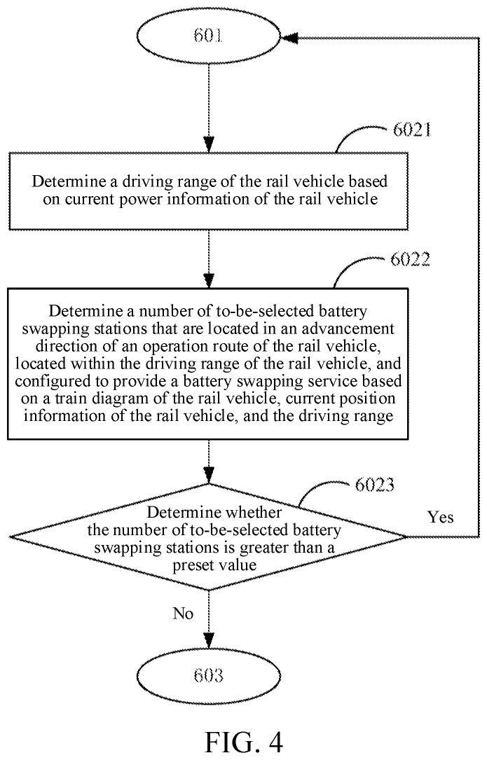

In an embodiment, referring to FIG. 4, FIG. 4 is a detailed flowchart of step 602. Step 602 may include the following steps.

Step 6021: A driving range of the rail vehicle 200 is determined based on the current power information of the rail vehicle 200.

In an embodiment, the current power information includes current residual capacity information and a power range of the battery pack of the rail vehicle 200, that is, the battery swapping management platform 100 may directly read the power range of the battery pack of the rail vehicle 200 from the current power information of the rail vehicle 200. In another embodiment, the current power information includes the current residual capacity information of the battery pack of the rail vehicle 200, that is, the battery swapping management platform 100 may calculate the power range of the battery pack of the rail vehicle 200 based on the current power information of the rail vehicle 200. The power range of the battery pack of the rail vehicle 200 is a maximum distance that the rail vehicle 200 may further travel with the current residual capacity.

Step 6022: A number of to-be-selected battery swapping stations that are located in an advancement direction of an operation route of the rail vehicle 200, located within the driving range of the rail vehicle 200, and configured to provide a battery swapping service is determined based on a train diagram or an operation route of the rail vehicle 200, the current position information of the rail vehicle 200, and the driving range.

In this embodiment, the to-be-selected battery swapping stations are battery swapping stations where the rail vehicle 200 can reach by further running according to the train diagram with the current residual capacity. The train diagram of the rail vehicle 200 is compiled by the battery swapping management platform 100. The battery swapping management platform 100 may determine a distance between the rail vehicle 200 and each battery swapping station based on the current position information of the rail vehicle 200. In an embodiment, if a battery swapping station X located in the advancement direction of the rail vehicle 200 can provide a battery swapping service, and a distance between the battery swapping station X and the current position of the rail vehicle 200 is less than the driving range of the rail vehicle 200, it may be determined that the battery swapping station X is a to-be-selected battery swapping station.

Step 6023: It is determined whether the number of to-be-selected battery swapping stations is greater than a preset value. If the number of to-be-selected battery swapping stations is greater than the preset value, it is determined that the rail vehicle 200 does not have the battery swapping need, and step 601 is re-performed. If the number of to-be-selected battery swapping stations is equal to or less than the preset value, it is determined that the rail vehicle 200 has the battery swapping need, and step 603 is performed. It may be understood that the preset value is greater than or equal to 1. In an embodiment, the preset value is equal to 1. If the number of to-be-selected battery swapping stations is equal to 1, it means that the rail vehicle 200 can reach only one battery swapping station that can provide a power exchange service by further running according to the train diagram with the current residual capacity. If the rail vehicle misses the battery swapping station, the rail vehicle 200 cannot complete the operation plan with the current power. Therefore, the rail vehicle has the battery swapping need.

According to the method for controlling automatic battery swapping of a rail vehicle provided in the present disclosure, the vehicle information of the rail vehicle 200 is received, so that whether the rail vehicle 200 has the battery swapping need may be accurately determined, thereby achieving unified scheduling and planning for rail vehicles 200 and battery swapping stations. This not only achieves efficient and reliable operation of the system, but also achieves automatic matching between the rail vehicle 200 and the target battery swapping station 300 through synchronous control of the rail vehicle 200 and the target battery swapping station 300, thereby improving the automation level of battery swapping.

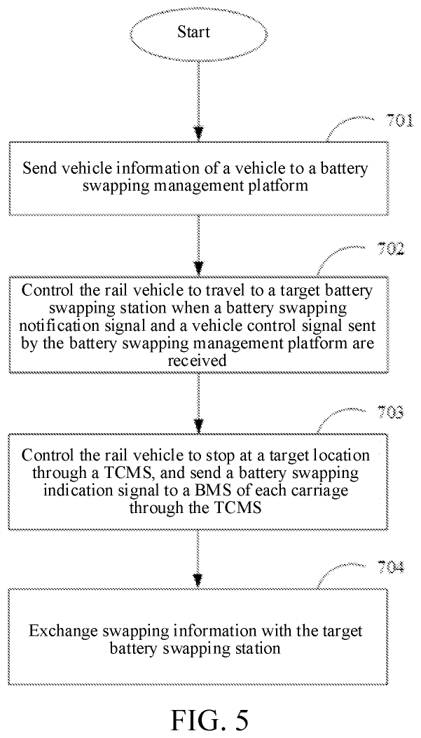

Referring to FIG. 5, an embodiment of the present disclosure further provides another method for controlling automatic battery swapping of a rail vehicle, which is applicable to a rail vehicle 200. In an embodiment, the method includes the following steps.

Step 701: Vehicle information of the vehicle is sent to a battery swapping management platform 100. The vehicle information includes current position information and current power information of the rail vehicle 200. The vehicle information is used by the battery swapping management platform 100 to determine whether the rail vehicle 200 has a battery swapping need. The battery swapping management platform 100 sends a battery swapping notification signal and a vehicle control signal to the rail vehicle 200 when determining that the rail vehicle 200 has the battery swapping need based on the vehicle information. The battery swapping notification signal includes position information of a target battery swapping station 300.

In an embodiment, the current power information includes current residual capacity information and a power range of a battery pack of the rail vehicle 200. The current power information of the rail vehicle 200 may be determined through the following steps.

Current residual capacity information of the battery pack of each carriage 201 is obtained through a BMS 230 of the corresponding carriage 201.

The current residual capacity information of the battery pack of each carriage 201 is sent to a TCMS 220 through the BMS 230 of the corresponding carriage 201.

A driving range of the rail vehicle 200 is calculated through the TCMS 220 based on the current residual capacity information of the battery pack of each carriage 201 and average energy consumption of the rail vehicle 200 in a preset running record, to obtain the current power information.

Step 702: The rail vehicle 200 is controlled to travel to a target battery swapping station 300 when the battery swapping notification signal and the vehicle control signal sent by the battery swapping management platform 100 are received. It may be understood that the rail vehicle 200 may reach a target battery swapping location based on the position information of the target battery swapping station 300.

Step 703: The rail vehicle 200 is controlled to stop at a target location through the TCMS 220, and a battery swapping indication signal is sent to the BMS 230 of each carriage 201 through the TCMS 220.

In this embodiment of the present disclosure, the target location is a target battery swapping location planned by the battery swapping management platform 100 for the rail vehicle 200, which is a position of a battery swapping site 301. In an embodiment, when the rail vehicle 200 stops at the target battery swapping location, positions of the carriages of the rail vehicle 200 are in a one-to-one correspondence with positions of a plurality of battery swapping apparatuses 320 in the target battery swapping station 300.

In this embodiment of the present disclosure, the battery swapping indication signal is configured to trigger the BMS 230 of each carriage 201 to exchange battery swapping information with the target battery swapping station 300. After receiving the battery swapping indication signal, the BMS 230 of each carriage 201 initiates a process of exchanging battery swapping information with the target battery swapping station 300.

Step 704: The battery swapping information is exchanged with the target battery swapping station 300. In this embodiment of the present disclosure, the target battery swapping station 300 swaps the battery pack of the rail vehicle 200 based on the exchanged battery swapping information.

In this embodiment of the present disclosure, the BMS 230 of each carriage of the rail vehicle 200 exchanges battery swapping information of the battery pack of the corresponding carriage with the target battery swapping station 300 through wireless communication by a corresponding first wireless signal conversion module 240. In an embodiment, that the BMS 230 of each carriage exchanges the battery swapping information with the target battery swapping station 300 may include: The BMS 230 of each carriage sends a corresponding battery swapping readiness signal and/or battery pack information of the corresponding carriage to the target battery swapping station 300 after completing a battery swapping preparation action. The battery swapping readiness signal may be configured to trigger the target battery swapping station 300 to start the battery swapping operation. The battery pack information of each carriage may be used by the target battery swapping station 300 to arrange a corresponding new battery pack adapting to a configuration parameter of each carriage.

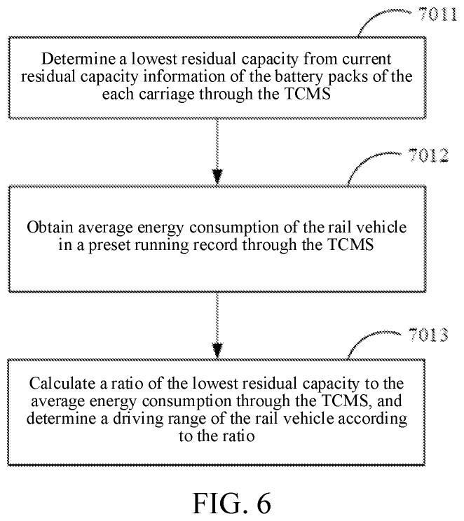

Further, referring to FIG. 6, the driving range of the rail vehicle 200 may be calculated through the following steps.

Step 7011: A lowest residual capacity is determined from the current residual capacity information of the battery packs of each carriage 201 through the TCMS 220.

Step 7012: The average energy consumption of the rail vehicle 200 in the preset running record is obtained through the TCMS 220. In an embodiment, average energy consumption of the rail vehicle 200 within latest 50 km is 10% of consumption of a total capacity of the battery pack for travelling by 1 km.

Step 7013: A ratio of the lowest residual capacity to the average energy consumption is calculated through the TCMS 220, and the ratio is determined as the driving range of the rail vehicle 200.

In order to facilitate description of a calculation process of the driving range of the rail vehicle 200, this embodiment further provides a calculation example.

In this example, the residual capacity information of the battery pack is a state of charge (SOC) of the battery pack. If it is assumed that the rail vehicle 200 includes three carriages, the average energy consumption of the rail vehicle 200 within the latest 50 km is 10% of consumption of a total capacity of the battery pack for travelling by 1 km, and current SOC values of the battery packs in the three carriages are 70%, 80%, and 90% respectively, the lowest SOC value is 70%. In this case, the driving range of the rail vehicle 200 is calculated as 7 km.

According to the method for controlling automatic battery swapping of a rail vehicle provided in the present disclosure, based on the relevant battery swapping instruction signal sent by the battery swapping management platform 100, the rail vehicle 200 may be automatically controlled to travel and park at the target battery swapping location, so that the target battery swapping station 300 performs a battery swapping operation. In addition, in the method, the battery swapping information is exchanged between the rail vehicle 200 and the target battery swapping station 300, so that the target battery swapping station 300 performs battery swapping based on the exchanged information without intervention of an operator, thereby reducing labor costs and improving battery swapping efficiency.

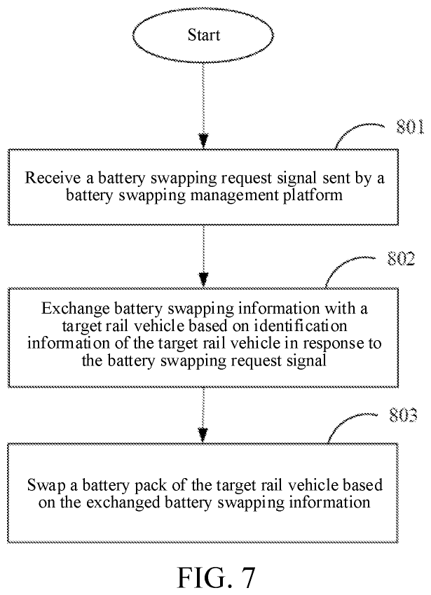

Referring to FIG. 7, an embodiment of the present disclosure provides still another method for controlling automatic battery swapping of a rail vehicle, which is applicable to a battery swapping station 300. In an embodiment, the method includes the following steps.

Step 801: A battery swapping request signal sent by a battery swapping management platform 100 is received. The battery swapping request signal includes identification information of a target rail vehicle 200.

In an embodiment, the identification information of the target rail vehicle 200 includes an identification code of the target rail vehicle. The target rail vehicle 200 is a rail vehicle scheduled by the battery swapping management platform 100 for battery pack swapping in a current battery swapping station.

Step 802: Battery swapping information is exchanged with the target rail vehicle 200 based on the identification information of the target rail vehicle 200 in response to the battery swapping request signal.

In an embodiment of the present disclosure, step 802 includes the following steps.

Step A: The battery swapping request signal is responded through a battery swapping server 310, and a database is searched for a communication account and password information of the target rail vehicle 200 based on the identification code of the target rail vehicle 200.

In this embodiment of the present disclosure, the database of the battery swapping server 310 may store an identification code of each rail vehicle 200 in a system 10 for controlling automatic battery swapping of a rail vehicle and corresponding communication account and password information. It should be noted that, each carriage 201 of each rail vehicle 200 corresponds to a communication account and a password. The battery swapping server 310 may search the database for a serial number of each carriage 201 of the target rail vehicle and a communication account and password information of each carriage 201 based on the identification code of the target rail vehicle 200.

Step B: The communication account and the password information of the target rail vehicle 200 are configured for a second wireless signal conversion module 330 through the battery swapping server 310, so that a first wireless signal conversion module 240 is connected with a second wireless signal conversion module 330 and exchanges the battery swapping information.

In an embodiment, a battery swapping site 301 and a corresponding battery swapping apparatus 320 and second wireless signal conversion module 330 are first arranged for each carriage 201 of the target rail vehicle 200 through the battery swapping server 310 based on the serial number of each carriage 201 of the target rail vehicle 200. Then a communication account and a password are configured for the second wireless signal conversion module 330 corresponding to each carriage 201 through the battery swapping server 310 based on the communication account and the password information of each carriage 201, so that the first wireless signal conversion module 240 of each carriage 201 establishes a point-to-point connection to the corresponding second wireless signal conversion module 330.

Step 803: A battery pack of the target rail vehicle 200 is swapped based on the exchanged battery swapping information.

In an embodiment, the received battery swapping information is sent to the battery swapping server 310 through the second wireless signal conversion module 330 corresponding to each carriage 201. In an embodiment, the BMS 230 of each carriage sends a corresponding battery swapping readiness signal and/or battery pack information of the corresponding carriage 201 to the battery swapping server 310 through the corresponding second wireless signal conversion module 330 after completing a battery swapping preparation action.

Then a corresponding battery swapping apparatus 320 is controlled through the battery swapping server 310 based on the battery swapping information to swap the battery pack of the corresponding carriage 201. In an embodiment, the battery swapping server 310 controls the corresponding battery swapping apparatus 320 to start the battery swapping operation after receiving the battery swapping readiness signal sent by the corresponding carriage 201 through each second wireless signal conversion module 330.

In this embodiment of the present disclosure, the battery swapping station 300 sends the received battery swapping information to the battery swapping server 310 through the second wireless signal conversion module 330 of each battery swapping site 301, and then controls, through the battery swapping server 310 based on the battery swapping information, each battery swapping apparatus 320 to swap the battery pack of the corresponding carriage 201. In some embodiments, the battery swapping station 300 may further monitor the battery swapping process in real time through the battery swapping server 310. In an embodiment, if the battery swapping server 310 receives a battery swapping readiness signal of a carriage n of the rail vehicle 200, the battery swapping server sends a battery swapping start signal to the corresponding battery swapping apparatus 320 to control the battery swapping apparatus 320 to swap a battery pack of the carriage n. In an embodiment, if the battery swapping server 310 detects an abnormality, the battery swapping server sends a battery swapping stop signal to all battery swapping apparatuses 320 to control the battery swapping apparatuses 320 to swap the battery pack of the carriage n.

According to the method for controlling automatic battery swapping of a rail vehicle provided in the present disclosure, a communication connection is automatically established with the target rail vehicle 200 based on the battery swapping request signal sent by the battery swapping management platform 100, which achieves precise matching between each carriage 201 and a corresponding battery swapping apparatus 320, so that the battery swapping apparatus 320 may be controlled to swap a battery pack of the corresponding carriage 201, thereby achieving a more intelligent battery swapping process.

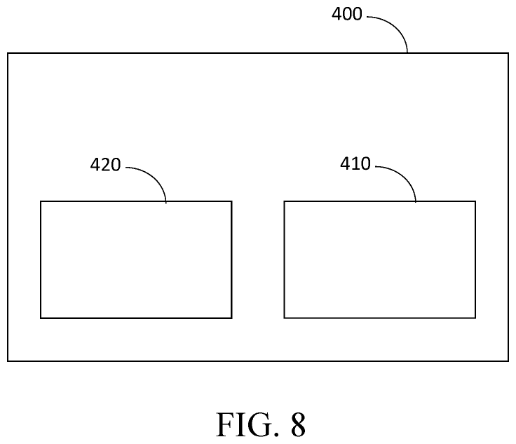

Referring to FIG. 8, an embodiment of the present disclosure provides an electronic device 400. The electronic device 400 includes a processor 410 and a memory 420. The memory 420 stores instructions executable by the processor 410. The instructions, when executed by the processor 410, perform the steps of the method for controlling automatic battery swapping of a rail vehicle in each embodiment described above.

In an embodiment, in an embodiment, the instructions, when executed by the processor 410, perform the steps of the method for controlling automatic battery swapping of a rail vehicle in the embodiment shown in FIG. 3.

In an embodiment, in an embodiment, the instructions, when executed by the processor 410, perform the steps of the method for controlling automatic battery swapping of a rail vehicle in the embodiment shown in FIG. 5.

In an embodiment, in an embodiment, the instructions, when executed by the processor 410, perform the steps of the method for controlling automatic battery swapping of a rail vehicle in the embodiment shown in FIG. 7.

The present disclosure further provides a non-transitory computer-readable storage medium storing instructions thereon. The instructions, when executed by a processor, perform the steps of the method for controlling automatic battery swapping of a rail vehicle in each embodiment described above.

In an embodiment, in an embodiment, the instructions, when executed by the processor, perform the steps of the method for controlling automatic battery swapping of a rail vehicle in the embodiment shown in FIG. 3.

In an embodiment, in an embodiment, the instructions, when executed by the processor, perform the steps of the method for controlling automatic battery swapping of a rail vehicle in the embodiment shown in FIG. 5.

In an embodiment, in an embodiment, the instructions, when executed by the processor, perform the steps of the method for controlling automatic battery swapping of a rail vehicle in the embodiment shown in FIG. 7.

A person of ordinary skill in the art may understand that all or some of the processes of the method in the above embodiment may be implemented by a computer program instructing relevant hardware in the present disclosure. The program may be stored in a computer-readable storage medium. When the program is executed by a processor, the steps of each method embodiment described above may be implemented. The computer program includes computer program code. The computer program code may be in the form of source code, object code, an executable file, some intermediate forms, or the like. The computer-readable medium may include any entity or apparatus capable of carrying the computer program code, a recording medium, a USB flash drive, a mobile hard disk, a magnetic disc, an optical disc, a computer memory, a read-only memory (ROM), a random access memory (RAM), an electric carrier signal, a telecommunications signal, and a software distribution medium. It should be noted that, the content contained in the computer-readable medium may be properly added or omitted according to the requirements of legislation and patent practice in the jurisdiction. For example, in some jurisdictions, according to legislation and patent practice, the computer-readable medium does not include the electrical carrier signal and the telecommunications signal.

For a person skilled in the art, it is obvious that the present disclosure is not limited to the details of the above exemplary embodiments, and may be implemented in another form without departing from the spirit or basic features of the present disclosure. Therefore, from any perspective, the embodiments should be considered as exemplary and non-limiting, and the scope of the present disclosure is limited by the appended claims rather than the above description. Therefore, all variations within the meaning and scope of the equivalents of the claims fall within the present disclosure. No reference numeral in the claims is to be considered as a limitation to the related claims. Furthermore, it is obvious that the term “include” does not exclude another unit or step, and the singular form does not exclude the plural form. The multiple units or devices stated in the apparatus claims may also be implemented by one unit or apparatus through software or hardware.

Although the embodiments of the present disclosure have been shown and described, a person of ordinary skill in the art may understand that various changes, modifications, replacements, and variations may be made to the embodiments without departing from the principle and spirit of the present disclosure, and the scope of the present disclosure is as defined by the appended claims and their equivalents.

### REFERENCE NUMERALS

System for controlling automatic battery 10 swapping of rail vehicle
Battery swapping management platform 100
Battery swapping station 300
Rail vehicle 200
Vehicle on-board controller 210
Carriage 201
Train control and management system 220
Battery management system 230
First wireless signal converter 240
Battery swapping site 301
Battery swapping server 310
Battery swapping apparatus 320
Second wireless signal converter 330
Electronic device 400
Processor 410
Memory 420
Step 601-604, 6021-6023, 701-704, 7011-7013, 801-803

What is claimed is:

1. A method for controlling battery swapping of a rail vehicle, applicable to a battery swapping management platform, comprising:
receiving, by the battery swapping management platform, vehicle information sent by the rail vehicle, wherein the vehicle information comprises current position information and current power information of the rail vehicle;
determining, by the battery swapping management platform, whether the rail vehicle has a battery swapping need based on the vehicle information of the rail vehicle;
in response to determining that the rail vehicle has the battery swapping need, determining, by the battery swapping management platform, a target battery swapping station according to the battery swapping need; and
sending, by the battery swapping management platform, a battery swapping notification signal and a vehicle control signal to the rail vehicle, and sending a battery swapping request signal to the target battery swapping station, wherein the battery swapping notification signal comprises position information of the target battery swapping station, the vehicle control signal is configured to control the rail vehicle to travel to the target battery swapping station, and the battery swapping request signal comprises identification information of the rail vehicle and is configured to request the target battery swapping station to swap a battery pack for the rail vehicle.

2. The method according to claim 1, wherein the determining, by the battery swapping management platform, whether the rail vehicle has the battery swapping need based on the vehicle information of the rail vehicle further comprises:
determining a driving range of the rail vehicle based on the current power information of the rail vehicle;
determining, based on an operation route of the rail vehicle, the current position information of the rail vehicle, and the driving range, a number of to-be-selected battery swapping stations that are located in an advancement direction of the operation route of the rail vehicle, located within the driving range of the rail vehicle, and configured to provide a battery swapping service; and
in response to that the number of to-be-selected battery swapping stations is equal to or less than a value, performing the battery swapping according to the battery swapping need.

3. The method according to claim 2, wherein:
the current power information comprises current residual capacity information and a power range of the battery pack of the rail vehicle; and the determining the driving range of the rail vehicle based on the current power information of the rail vehicle further comprises: reading the power range of the battery pack of the rail vehicle from the current power information of the rail vehicle; or
the current power information comprises the current residual capacity information of the battery pack of the rail vehicle; and the determining the driving range of the rail vehicle based on the current power information of the rail vehicle further comprises: calculating the power range of the battery pack of the rail vehicle based on the current power information of the rail vehicle.

4. A method for controlling battery swapping of a rail vehicle, applicable to the rail vehicle, comprising:
sending, by the rail vehicle, vehicle information of the rail vehicle to a battery swapping management platform; wherein the vehicle information comprises current position information and current power information of the rail vehicle, wherein the battery swapping management platform is configured to determine whether the rail vehicle has a battery swapping need based on the vehicle information of the rail vehicle, and to send a battery swapping notification signal and a vehicle control signal to the rail vehicle when determining that the rail vehicle has the battery swapping need, and wherein the battery swapping notification signal comprises position information of a target battery swapping station;
receiving, by the rail vehicle, the battery swapping notification signal and the vehicle control signal sent by the battery swapping management platform, and travelling to the target battery swapping station according to the battery swapping notification signal and the vehicle control signal; and
exchanging, by the rail vehicle, battery swapping information with the target battery swapping station for the target battery swapping station to swap a battery pack of the rail vehicle based on the battery swapping information.

5. The method according to claim 4, wherein:
the current power information comprises current residual capacity information and a power range of the battery pack of the rail vehicle;
the rail vehicle comprises a train control, management system (TCMS), and a plurality of carriages, and a battery pack and a battery management system (BMS) disposed in each of the carriages; and
the method further comprises:
obtaining current residual capacity information of the battery pack of each of the carriages through the BMS of each of the carriages;
sending the current residual capacity information of the battery pack of each of the carriages the TCMS through the BMS of each of the carriages; and
calculating a driving range of the rail vehicle through the TCMS based on the current residual capacity information of the battery pack of each of the carriages and average energy consumption of the rail vehicle in a running record, to obtain the current power information.

6. The method according to claim 5, wherein the calculating the driving range of the rail vehicle through the TCMS based on the current residual capacity information of the battery pack of each of the carriages and the average energy consumption of the rail vehicle in the running record comprises:
determining a lowest residual capacity from the current residual capacity information of the battery pack of each of the carriages through the TCMS;
obtaining the average energy consumption of the rail vehicle in the running record through the TCMS; and
calculating a ratio of the lowest residual capacity to the average energy consumption through the TCMS, and determining the driving range of the rail vehicle according to the ratio.

7. The method according to claim 5, further comprising:
arriving at the target battery swapping station;
stopping at a target location, and sending a battery swapping indication signal to the BMS through the TCMS to trigger the BMS of each of the carriages to exchange battery swapping information with the target battery swapping station.

8. The method according to claim 5, wherein: the rail vehicle further comprises a vehicle on-board controller (VOBC); and the sending, by the rail vehicle, the vehicle information of the rail vehicle to the battery swapping management platform further comprises:
sending the vehicle information of the rail vehicle to the VOBC through the TCMS; and
sending the vehicle information to the battery swapping management platform by the VOBC.

9. The method according to claim 5, wherein: the rail vehicle further comprises a first wireless signal converter disposed in each of the carriages; and the exchanging, by the rail vehicle, battery swapping information with the target battery swapping station further comprises:
exchanging battery swapping information of the battery pack with the target battery swapping station by the first wireless signal converter.

10. A method for controlling battery swapping of a rail vehicle, applicable to a battery swapping station, comprising:
receiving, by the battery swapping station, a battery swapping request signal sent by a battery swapping management platform, wherein the battery swapping request signal comprises identification information of the rail vehicle; and
exchanging, by the battery swapping station, battery swapping information with the rail vehicle based on the identification information of the rail vehicle, and swapping a battery pack of the rail vehicle based on the battery swapping information.

11. The method according to claim 10, wherein:
the rail vehicle comprises a plurality of carriages and a first wireless signal converter disposed in each of the carriages; the identification information of the rail vehicle comprises an identification code of the rail vehicle; and the battery swapping station comprises a battery swapping server, a plurality of battery swapping sites, and a second wireless signal converter in each of the battery swapping sites; each of the battery swapping sites comprises a battery swapping apparatus; and
the exchanging, by the battery swapping station, the battery swapping information with the rail vehicle based on the identification information of the rail vehicle comprises:
responding to the battery swapping request signal through the battery swapping server, and searching a database for a communication account and password information of the rail vehicle based on the identification code of the rail vehicle; and
configuring the communication account and the password information of the rail vehicle for the second wireless signal converter through the battery swapping server, to connect the first wireless signal converter with the second wireless signal converter and to exchange the battery swapping information.

12. The method according to claim 11, wherein:
the searching the database for the communication account and password information of the rail vehicle based on the identification code of the rail vehicle further comprises:
searching the database for a serial number of each of the carriages of the rail vehicle and a communication account and password information of each of the carriages based on the identification code of the rail vehicle;
the configuring the communication account and the password information of the rail vehicle for the second wireless signal converter through the battery swapping server, to connect the first wireless signal converter with the second wireless signal converter further comprises:
determining a battery swapping site and a corresponding battery swapping apparatus and a second wireless signal converter for each of the carriages of the rail vehicle through the battery swapping server based on the serial number of each of the carriages of the rail vehicle; and
configuring a communication account and a password for the second wireless signal converter corresponding to each of the carriages through the battery swapping server based on the communication account and the password information of each of the carriages, to establishes a point-to-point connection between the first wireless signal converter of each of the carriages and a corresponding second wireless signal converter; and
the swapping the battery pack of the rail vehicle based on the battery swapping information further comprises:
sending the battery swapping information to the battery swapping server through the second wireless signal converter of each of the carriages; and
controlling, through the battery swapping server based on the battery swapping information, the battery swapping apparatus to swap the battery pack of a corresponding carriage.
